(19) United States
(12) Patent Application Publication
(10) Pub. No.: US 2007/0157671 A1
(43) Pub. Date: Jul. 12, 2007

(54) Method for crowning sheets of glass by pressing and suction

(75) Inventors: Herve Thellier, Pimprez (FR); Christophe Machura, Chevincourt (FR); Jerome Gobin, St. Leger aux Bois (FR); Gilles Garnier, Dompierre (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT GOBAIN GLASS FRANCE, FRANCE (FR)

(21) Appl. No.: 10/550,736

(22) PCT Filed: Mar. 24, 2004
(86) PCT No.: PCT/FR04/00716

§ 371 Date: Sep. 26, 2006

(30) Foreign Application Priority Data
Mar. 26, 2003 (FR) 0303686

(51) Int. Cl. C03B 31/00; C03B 21/00; C03B 23/02

(52) U.S. Cl. 65/106; 65/107; 65/287

(57) ABSTRACT

A method of bending at least one glass sheet including: allowing the glass to sag under gravity; then placing the central region of the one or more sheets in contact with a male former by advancing a female former supporting the sheet toward the male former, the male former being located above the female former with vertical movement of one with respect to the other being possible in a bending cell; then pressing the glass in its peripheral region between the male former and the female former; then holding the glass against the male former by partial vacuum, the pressing being continued; then discontinuing the pressing by separating the male former from the female former; and then cooling the glass outside the bending cell. The method makes it possible to produce bends with short radii of curvature in two perpendicular directions without leaving marks on the glass.

The present invention relates to a method of bending a glass sheet or a stack of superposed glass sheets in a bending cell.

The sheets to be bent, heated to the bending temperature in a horizontal oven through which they are carried by a conveyor are fed by the conveyor into the bending cell, in which there is a convex solid male former toward which the glass sheet is moved vertically by a concave annular female former, so as to be pressed between the male former and the female former.

The resulting bent glass sheets are intended for such things as glazing for cars, especially windshields, the glazing being in most cases laminated, i.e. consisting of at least two sheets of glass laid one on top of the other with a sheet of a plastic material such as poly(vinyl butyral) (PVB) between them.

Bent forms for car glazing are in great demand, the bending being defined in a first approach by one radius of curvature of a line in one direction of the glazing and by a second radius of curvature of a line in another direction of the glazing, the second line being perpendicular to the first. To give a general idea, the first radius of curvature may be from one meter to infinity and the second radius of curvature from five meters to infinity. Ever more pronounced curvatures in at least one of the two dimensions of the sheet are now demanded.

When producing single glazing, the glass sheets to be bent are introduced individually into the bending cell.

When producing laminated glazing, the number of glass sheets which the laminated glazing is to have (usually two) are laid one on top of the other, with a separating agent, such as calcium carbonate powder or kieselguhr powder, between them, and this stack is fed into the entrance of the oven. This makes it possible to achieve perfectly matching shapes in the case of glass sheets intended to be brought together in a single laminated glazing sheet. The bent sheets produced in this way are separated by hand, after cooling, before being joined together using the intermediate sheets of PVB-type (polyvinylbutyral) plastic.

Car makers demand the production of glazing with complex shapes, especially with high developability coefficients, and this with very good geometrical tolerances, in other words departing very little (less than 2 mm or even less than 1 mm) from the intended shape. What is more, the glazing must have as little marking as possible from the bending tools, especially in the central area. Finally, when the glazing comprises at least one layer such as a sun screening layer, e.g. a layer comprising silver, the bending process must not damage the layer(s).

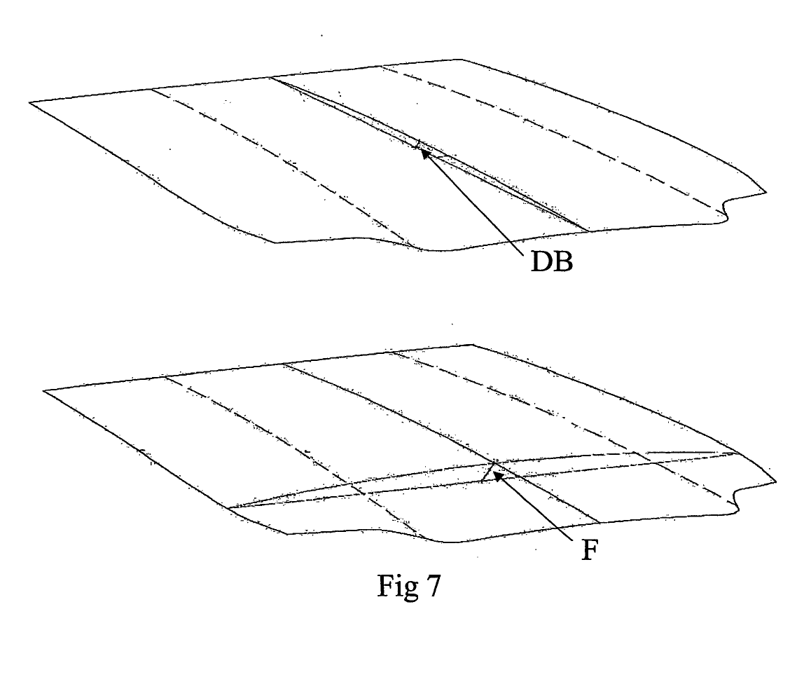

In this text, the term “deflection” means the depth of bend of the longest arc, which usually corresponds to the most pronounced bend. This corresponds to the line segment whose ends are on the center of said arc and on the center of the chord of this arc (see in particular the deflection F as shown in FIG. 7). The secondary bend, known as the “cross bend” or “cross curvature” is perpendicular to the first bend, and is generally less pronounced than the first bend. “Cross bend” also refers to the depth of this secondary bend formed by the arc perpendicular to the longest arc and corresponds to the line segment whose ends are on the center of said arc and on the center of the chord of this arc (see in particular the cross bend DB as shown in FIG. 7).

The term “skeleton” refers to a narrow strip of metal closed around on itself to form a support, on the narrow upper edge of which a glass sheet is laid (see FIG. 8a). The thickness of the narrow edge is generally from 0.1 to 1 cm. In the context of the present application, a skeleton supports a glass sheet in such a way that the narrow edge of the glass sheet is at least 2 cm and generally from 2 to 10 cm away from said skeleton. This prevents the “bathtub” sagging effect which would occur if the support were too close to the edge of the glass.

The term “frame” refers to a strip that is similarly closed around on itself but offers as a supporting surface not its narrow edge but one of its large surfaces (see FIG. 8b), the width of which is generally between 1 and 4 cm. Generally speaking, a frame supports a glass sheet by supporting it at its periphery, including under the narrow edge of said sheet.

In the context of the present application, the term glazing may cover an individual glass sheet or a plurality of superposed glass sheets.

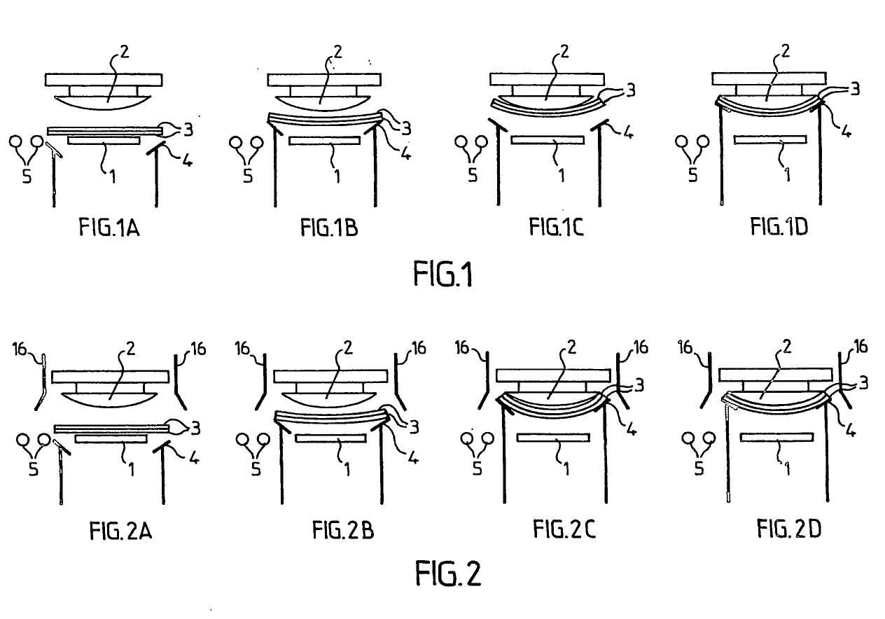

WO 95/01938 discloses a method of bending in a bending cell containing, as can be seen in FIG. 1 in the appended drawing:
a support member consisting of a hot air cushion 1;
above, the convex male former 2 equipped with means for holding a glass sheet or several superposed glass sheets 3 (two of these sheets being shown in FIG. 1) in contact with itself; and
below, the concave annular female former 4, which can be moved between a low position below the plane of conveyance of the glass sheets 3 and a high position close to the male former 2. This female former 4, also referred to in this description as a “frame”, is a metal structure that offers a greater surface area of contact with the glass sheet 3 than a single linear contact (as happens with a skeleton).

In the method of WO 95/01938 the sheets 3 are fed by the rollers 5 into the bending cell and released onto the hot air cushion 1 (FIG. 1A). As soon as the glass 3 is correctly positioned, the annular frame 4 is raised. As it rises, the glass 3 sags through the annular frame 4 due to gravity (FIG. 1B). As soon as the annular frame 4 has finished rising and the bend has thus begun to be formed, the glass sheet 3 or stack of glass sheets 3 comes under a partial vacuum. The glass 3 therefore detaches completely from the annular frame 4 and clings to the convex surface of the male former 2 (FIG. 1C). The last step in this known bending process is a pressing operation between the male former 2 and the annular frame 4 of the glass sheet 3 or stack of glass sheets 3. This pressing is simply a finishing step intended to finish the geometry of the edges, without creating compression stresses in order evenly to distribute the excess material (FIG. 1D).

This known process has been found not to be able to produce highly bent sheets, especially when several sheets are stacked together, because for curvatures with short radii it is no longer possible to prevent the edges of the glass sheet wrinkling, and so causing optical defects. This happens particularly with forms of glazing that have a coefficient of non-developability locally greater than 2 (especially in the case of several superposed sheets), said coefficient of non-developability being defined by the formula D=Ln (10⁷/R₁×R₂) where Ln is the natural logarithm, and R₁ and R₂ are the main radii of curvature at the point considered, expressed in millimeters. Moreover, experience has shown that in the case in which several sheets are stacked (to make laminated glazing), not all the sheets can be held by the vacuum properly and they separate during the partial vacuum step, as those sheets which are not in contact with the male former are very likely not to follow the sheet placed in direct contact with the former. This results in disturbances necessitating production line stoppages.

Equally, this known process demands large volumes of air, both during the partial vacuum phase (FIG. 1C), and also because of the use of an air cushion. It should be understood too that the air cushion cannot be used to push the glass toward the convex upper former, its only use being to keep the sheets at a fixed distance (generally 2 to 6 mm) from a component from which the air of said cushion is blowing.

It is an object of the present invention to solve these problems. In particular, the method according to the invention is a short-duration bending method capable of producing deep concavities, for producing both deflection and cross bend, more particularly for superposed sheets, and with a minimum or absence of marks. In addition it does not require the blowing of large volumes of air.

It has thus been discovered that an initial sag, preferably of mainly cylindrical type that preferably creates a deflection approximately equal to the final deflection (the deflection imposed by the male convex former), followed by pressing the perimeter of the glazing to define the peripheral shape of the glass sheet (or stack of glass sheets), followed in turn by applying a partial vacuum to the central part of the glass while still maintaining the peripheral pressing, has the effect of causing the glass to flow while said partial vacuum is being applied in such a way as evenly to distribute the effects produced by the two bends creating orthogonal concavities, and this for what may be small radii (equivalent to deep curvatures), such as 80 to 200 mm, for example about 100 mm. Immediately before the outline of the sheet is pressed, the central part of the glazing comes into contact with the opposing part of the male former. It might be supposed that a single forming of the periphery of the sheet would be sufficient to give the glazing its desired shape. However, it has been found that during the pressing of the periphery of the glazing, defects appear in the central part of the glazing owing to a partial loss of contact with the male former in this area (resulting in the formation of “pockets” or “bubbles”). The partial vacuum solves this problem by forcing the glazing into perfect contact with the male former. The result is to give the glazing almost exactly the geometry of the convex former. It is thus possible to manufacture glazing to a very small manufacturing tolerance, meaning that its geometry departs very little (less than 2 mm error, or even less than 1 mm error) from the desired shape.

In addition, if a stack of several sheets of glass undergoes bending by the method of the invention, the pressing of the periphery clamps together the edges of the mating glass sheets, even to the extent of sealing the space between said sheets at the periphery. As a consequence of this, the strength of the partial vacuum applied to the first sheet—the sheet intended to be placed against the male former—is communicated to the second sheet, and so on. This solves the problem of the poor grip on the sheet or sheets furthest from the male former when bending a stack of glass sheets for the purposes of producing laminated glazing. The pressing thus has two effects: in the first place it creates a peripheral seal between the sheet directly in contact with the male former, but also it additionally creates a peripheral seal between the individual glass sheets. This is why the application of a partial vacuum can result in a force that presses all of the glass sheets toward the male former, the force of the partial vacuum being as it were communicated from sheet to sheet. The formation of bubbles or pockets is thus not only eliminated between the male former and the glass sheet touching it, but also between the individual sheets. As a result, all the glass sheets have exactly the same shape, and this shape is very close to the intended shape.

In accordance with the invention, it is preferred not to begin to apply the partial vacuum until the first glass sheet is in contact with the male convex former, as its premature application would serve no purpose and it is not advisable to apply suction unnecessarily. Besides, it would cause movement of gases, and it is generally desirable to reduce these to a minimum inside the bending cell.

The subject of the present invention is therefore firstly a method of bending at least one glass sheet (one glass sheet or a stack of glass sheets) by forming said sheet or said stack between a convex solid male former and a concave annular female frame or former, said male former being located above said female former with vertical movement of one with respect to the other being possible in a bending cell in which an ambient temperature identical or approximately identical to the bending temperature is preferably maintained, the glass sheet or stack of glass sheets, heated to the bending temperature in a horizontal oven through which it travels on a conveyor, being subjected to forming after first undergoing a gravity-induced sag, which method is characterized in that a gravity-induced sag is preferably introduced under conditions leading to or leading essentially to a deflection f approximately equal to the final deflection and in that, for the forming process, the central region of said sheet (3) or stack of sheets (3) is first placed in contact with the male former (2), the peripheral region of said sheet (3) or stack of sheets (3) is then pressed between the male former (2) and the female former, and said sheet or stack of sheets is then held by partial vacuum against the male former, during which time the pressing is continued.

The expression “leading to or leading essentially to a deflection f” means that a deflection f is formed in one direction of the surface of the sheet, it being possible for a cross bend to be formed in the other direction also, though much smaller than the cross bend imposed during the pressing.

Thus, the invention relates to a method of bending at least one glass sheet comprising
a step of allowing the glass to sag under gravity; then
placing the central region of said one or more sheets in contact with a male former by advancing a female former supporting said sheet toward said male former, said male former being located above said female former with vertical movement of one with respect to the other being possible in a bending cell;
then a phase of pressing the glass in its peripheral region between the male former and the female former; then
a phase of holding the glass against the male former by partial vacuum, pressing being continued; then
discontinuing the pressing by separating the male former from the female former; and then
a step of cooling the glass outside the bending cell.

In the method of the invention, a sag is introduced that may produce a deflection f of from 20 mm to 400 mm for a final deflection of from 20 mm to 490 mm. This sag is preferably of the mainly cylindrical type. The adjective “cylindrical” means not that the form obtained is exactly cylindrical but more that the result is a concavity principally in one direction, as for a cylinder. Here, the sag is mainly cylindrical, i.e. a more pronounced concavity is obtained in one direction to create the deflection, and a less pronounced concavity in the direction perpendicular to the first direction (the cross bend). The intermediate deflection f created by this sag in the main direction corresponding to the deepest concavity represents preferably 80 to 100% of the deflection imposed by the male convex former. The cross bend created by this sag in the secondary direction corresponding to the shallower concavity varies from 10 to 150 mm and represents preferably 10 to 50% of the final cross bend. This sagging phase is relatively short and may last, in the case of two superposed sheets, from 2 to 10 min. This short a period is highly favorable to maintaining the integrity of an optional sun-screening layer containing silver. A short sag time is also favorable to limiting the marking of the glazing by the tool supporting it while it sags, especially if a skeleton is used. The short sagging time results in a mainly cylindrical sag. If sagging were allowed to continue for longer, it would become more spherical in character (a more pronounced cross bend). The sag support is of course of a shape that leads to the desired cylindrical sag, in other words the long sides of the support are curved sufficiently to allow the two long edges of the glazing to sink sufficiently.

In a first embodiment of the present invention, the glass sheet or stack of glass sheets is fed into the bending cell in a flat condition on a conveyor consisting of a flat bed of cylindrical rollers, the glass sheet or stack of glass sheets entering the bending cell and becoming motionless on a support means that supports its central part, this means being surrounded by the annular female former. The sag phase is then conducted entirely within the bending cell as the annular female former holding the sheet or stack of sheets rises, which allows the sag to occur through said female former. In this first embodiment the annular female former acts first as a sag support and then as a pressing means. It does not have to be covered with a fibrous material such as a felt or knit fabric, but this is not however ruled out.

In a variant of this first embodiment, the glass sheet is fed into the bending cell on a shaking bed placed in a tunnel oven, said bed consisting of shaping rods (rollers with a sunken shape, sometimes known as “handlebars”) in order to initiate the bent shape, by progressive sagging, to the sheet(s), the glass sheet or stack of glass sheets then entering the bending cell and becoming motionless on a support means that supports its central part, this means being surrounded by the annular female former. The sag phase then takes place in the bending cell as the annular female former holding the sheet or stack of sheets rises, which allows the sag to occur through said female former. The abovementioned support means is here generally an air cushion.

In a second, particularly preferred embodiment, the sag is introduced to the glass sheet or stack of glass sheets at least partly while it is being transported through a tunnel oven leading to the bending cell where the pressing step is to be performed, said sag being introduced at least partly on a sag support which in turn is being transported on a conveyor carriage which travels through the tunnel oven and becomes motionless in the bending cell over the vertically movable means, said means being surrounded by the annular female former, means being provided for discharging the carriage carrying said support once the latter is motionless, and means being provided for discharging the sag support once the glass sheet or stack of glass sheets is supported around its periphery by the annular female former.

When the sag support is motionless in the bending cell, said support occupies an area inscribed entirely (seen from above) within the annular female former, in such a way that said support can pass through the latter when said annular female former rises toward the male former, carrying the sheet or stack of sheets with it as it goes.

The sag support may be a solid, perforated or open-worked surface or a frame, but is advantageously a skeleton, the glass sheet 3 (or stack of glass sheets 3) to be transported being laid on the upper edge of the skeleton. The sag support is preferably covered with a fibrous material such as a felt or woven or knit fabric that is resistant to the bending temperatures (generally a refractory metal or ceramic). Various different “skeletons” can be used, depending among other things on the size of the deflection. For smaller deflections (less than, say, 200 mm) it is generally possible to use a fixed (that is, not jointed) skeleton. For larger deflections (greater than, say, 200 mm) it is also generally possible to use a jointed skeleton such as that disclosed in EP 448 447 A. In this embodiment, the annular female former does not have to be covered with a fibrous material such as a felt or a woven or knit fabric resistant to the bending temperatures (generally a refractory metal or ceramic) but such a covering is also possible.

The vertically mobile means advantageously is a vertical column capable of traveling up and down in the bending cell.

In accordance with various particular embodiments of the method according to the present invention:
pressing is applied for 0.1 to 10 seconds;
the partial vacuum is produced by a pressure drop created through the male former;
the partial vacuum is applied at the same time as the pressing;
following application of the partial vacuum with maintenance of the pressing, the next step in the method is to remove the pressing while maintaining a partial vacuum, preferably also by means of a skirt around the male former during the time required to retrieve the bent sheet or stack of bent sheets on a cooling support such as a cooling skeleton or preferably a cooling frame;
the bending is carried out at a temperature of less than or equal to 640° C., especially at a temperature of from 590 to 630° C.; and
in the case of a stack of glass sheets for making laminated glazing, several glass sheets are superposed with a separating powder such as calcium carbonate or kieselguhr interposed around the perimeter.

In the case of two superposed glass sheets, generally between 2 min 10 sec and 8 min elapse between the moment when the sheets are laid on the sag support and the moment when the sheets leave the bending cell.

Within the scope of the invention, during the separation of the male former from the female former, the glass remains in contact with the male former under the effect of a partial vacuum.

The partial vacuum applied through the male convex former may be applied through the whole of its surface area. The partial vacuum is preferably applied in a peripheral region surrounding another more central region in which positive gas pressure is applied. In this case the strength of the partial vacuum is greater than that of the positive gas pressure, so that the sum effect is that a partial vacuum is applied to the upper sheet. If positive gas pressure is applied in the central region, the male convex former is provided with a fibrous material (felt, knit fabric or the like) allowing the air to pass sideways through said fibrous material, that is to say parallel to the contact surface. The positive gas pressure is thus sufficiently moderate for there to be no loss of contact between the upper glass sheet and the covered male convex former. This gentle positive gas pressure produces a very thin cushion of air that reduces the contact pressure between the upper sheet and the male convex former with its fibrous material, and this further reduces the risk of the glass being marked by the contact.

Also preferably, a skirt surrounds the male convex former so that a partial vacuum can also be applied around the outside of the glazing adjacent to the narrow edge(s) of the glass sheet(s). Overall, the total partial vacuum applied (the sum of the partial vacuums applied through the convex former on the one hand, and through the skirt on the other) is enough to keep the glass sheets in contact with the male former when the female former is removed and is no longer in contact with the glass following the pressing phase. During the pressing phase, it is not essential to apply the partial vacuum through the skirt because the glass is held in contact by the female former. The main need for the partial vacuum through the skirt is when several glass sheets are superposed and the female former is lowered, so that the complete stack of glass sheets is maintained in contact with the male former. However, in practice it is also possible to run all the partial vacuums simultaneously (both through the skirt and through the male former).

Thus, when several glass sheets are superposed and are being bent at the same time as each other, during the separation of the male former from the female former, the glass remains in contact with the male former under the effect of a partial vacuum which is preferably at least partly applied through a skirt surrounding the male former.

Next, while the glass is in contact with the male former under the effect of a partial vacuum, a cooling support is brought under the glass, the partial vacuum is then stopped to allow the glass to rest on said cooling support, and said cooling support then takes the glass away for the cooling step.

The present invention also relates to the application of the method as defined above to the production of glazing having locally a coefficient of non-developability greater than 2 or even greater than 3, or even greater than 4. Glazing with high coefficients of non-developability possibly exceeding 3 or even 4 include for example the rear windows of motor vehicles (which generally include a single sheet of toughened glass), while glazing with lower coefficients of non-developability which may nonetheless be greater than 2 or even greater than 3 and are often between 2 and 3 include for example laminated windshields (generally comprising two glass sheets) for motor vehicles.

Lastly, the present invention relates to a bending system for carrying out the method as defined above with reference to the second embodiment, characterized in that it comprises:
an oven, generally comprising among other things a horizontal part;

inside the oven, a system for transporting the glass (glass sheet or sheets) placed on a sag support particularly of skeleton type, that can be carried on a carriage;

a bending cell comprising a bending oven, having a means for receiving and immobilizing the glass-carrying sag supports transported by said transport system, a frame or annular female former surrounding said receiving/immobilizing means and a convex male former located above the annular female former, means being provided for discharging the carriages from the bending cell, means being provided for discharging the sag supports from the bending cell, and means being provided for moving vertically on the one hand the annular female former and on the other hand the means of receiving and immobilizing the sag supports and for controlling the speed of movement. These last means may be power screws located outside the thermally insulated chamber.

The invention thus provides a bending system for carrying out the method according to the invention comprising an oven in which is a system for transporting the skeleton-supported glass that moves the skeleton(s) to a bending cell, said cell comprising a frame or annular female former, the skeleton occupying an area inscribed entirely, seen from above, within the annular female former, and a convex male former located above the annular female former, means being provided for discharging the skeleton(s) from the bending cell, means being provided for moving vertically on the one hand the annular female former, and said male former being provided with means capable of applying a partial vacuum through its convex surface.

To explain the method of the present invention more clearly, several particular embodiments of it will now be described for indicative purposes, no limitation being implied, with reference to the appended drawing, in which:

FIG. 1 is a schematic side view of the different steps (FIGS. 1A to 1D) of a method of forming a stack of two glass sheets as disclosed in WO 95/011938;

FIG. 2 is a view similar to FIG. 1, showing the different steps (FIGS. 2A to 2D) of a forming method in a first embodiment of the invention;

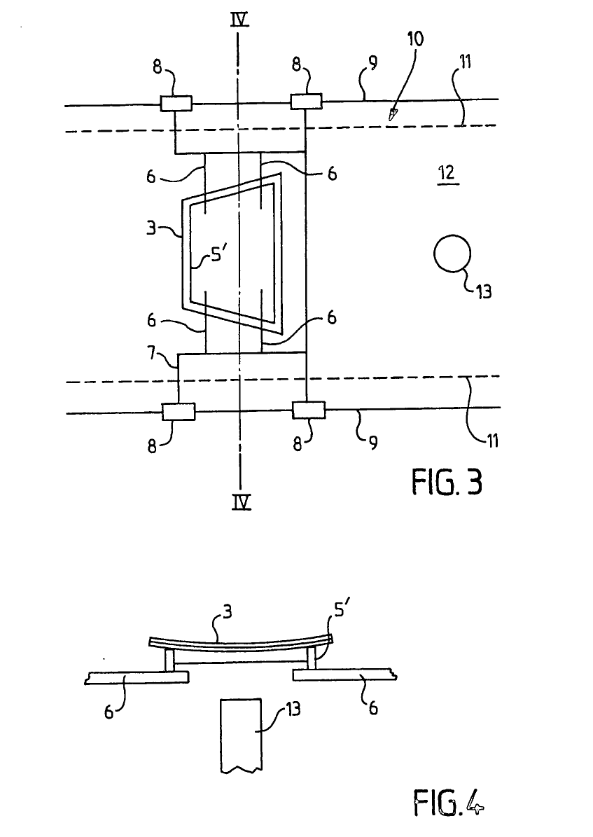

FIG. 3 is a schematic top view of the inside of an oven that feeds glazing to a bending cell, in a second embodiment of the present invention;

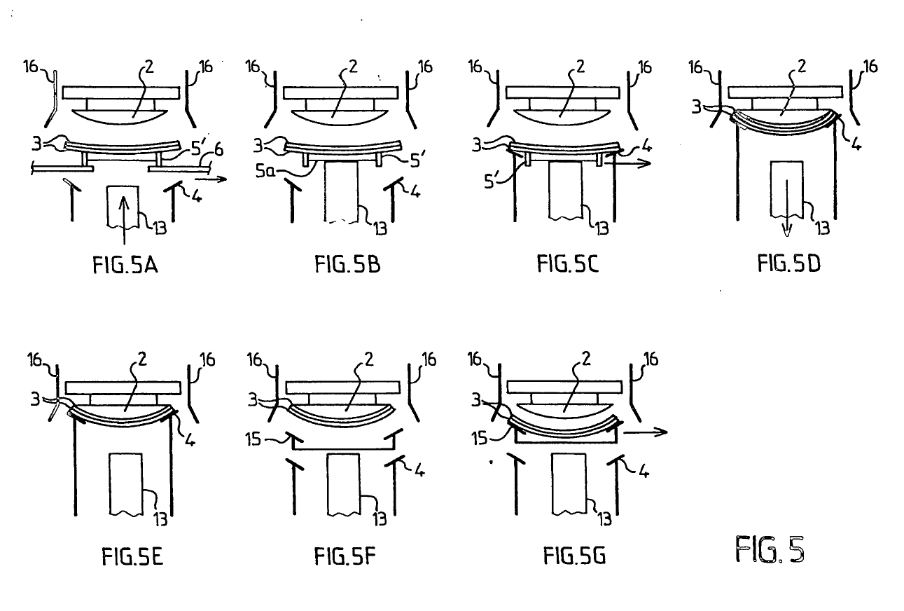

FIG. 4 is a schematic view taken on IV-IV as marked in FIG. 3;

FIG. 5 illustrates the different steps (FIGS. 5A to 5G) of this second embodiment;

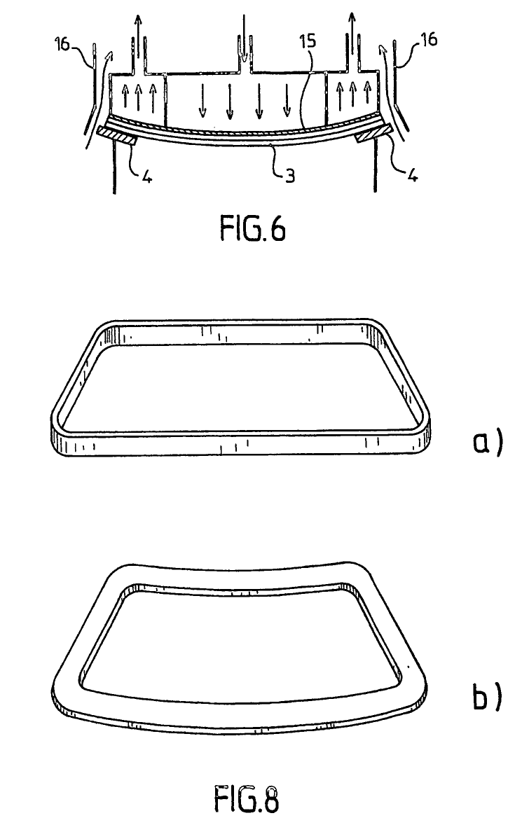

FIG. 6 illustrates the phase in which partial vacuum and pressing are applied in this second embodiment;

FIG. 7 illustrates on a motor vehicle windshield seen in perspective the so-called deflection and cross bend, the deflection F and the cross bend DB being shown on a motor vehicle windshield seen in perspective from its convex side; and

FIG. 8 shows the so-called skeleton (FIG. 8a) and frame (FIG. 8b).

The first embodiment of the method according to the present invention will now be described with reference to FIGS. 2A to 2D, which show, by way of example, the bending of a stack of two glass sheets intended to form a laminated windshield. It goes without saying that a single glass sheet could be bent.

FIG. 2A: Delivery of the Glass Sheets

The glass sheets 3 are heated to the bending temperature in a horizontal oven (tunnel oven) through which they are conveyed by a flat roller conveyor 5 which passes them into a bending cell identical to that described with reference to FIG. 1. In the present case the sheets 3 are flat as shown in FIG. 2A. Inside the bending cell, the sheets 3 are deposited on an air cushion 1, just as in WO 95/01938.

FIG. 2B: Sagging

The gravity-induced sagging of the sheets 3 is brought about in the same way as in WO 95/01938 with the difference however that it is sufficiently short to be mainly cylindrical and to give an intermediate deflection f approximately equal to the final deflection (cp. FIG. 2C). Various parameters can be varied to produce the desired intermediate deflection f, as is well known to those skilled in the art, these parameters being the temperature and the dwell time.

FIG. 2C: Pressing

After the glass has been allowed to sag through the annular frame 4, the frame is caused to continue its ascent toward the convex lower face of the male former 2 in order to press the periphery of the glass sheets 3.

FIG. 2D: Partial Vacuum

While the pressing is continued, the glass sheets 3 are exposed to a negative pressure created through the male former. This partial vacuum must be sufficient for the whole surface of the upper glass sheet 3 to be in contact with the solid convex upper former 2. Before the glass contacts the upper male former, there is no detachment from the annular frame 4.

After the application of the partial vacuum, as before, the glass sheets 3 are kept in contact with the male former 2 by the partial vacuum, particularly the additional partial vacuum through the skirt 16 and the lower sheet 3 cannot detach from the upper sheet 3 simply owing to the lowering of the female former 4. During or after of the lowering of the frame 4 beneath the plane of conveyance of the flat glass, a cooling support, such as a cooling frame is introduced underneath the male former to take the bent glass.

As soon as the partial vacuum is discontinued, the bent sheets 3 fall onto said cooling support which positions itself on a conveyor in order to carry the bent sheets away to the cooling station. The cooling may be a quench (especially in the case of a single sheet) or natural cooling, which is the case with laminated windshields (at least two superposed sheets).

In the method described above with reference to FIG. 2, the ways in which the glass is delivered (FIG. 2A) and allowed to sag (FIG. 2B) are not however preferred embodiments, although not ruled out of the present invention. Since the sag must preferably, in accordance with the present invention, be a mainly cylindrical sag leading to a deflection f approximately equal to the final deflection, then if the starting point is a flat piece of glass, it must be heated sufficiently.

The preferred way of delivering glass sheets 3 will now be described with reference to FIGS. 3 to 5. In this embodiment, the glass sheet or sheets 3 are delivered to the bending cell on skeletons 5′ that are transported through the heating oven and on which the sag develops gradually and can be very advanced or even completed or nearly completed when the sheet 3 is placed in the bending cell in the pressing position according to the invention.

In the case of superposed glass sheets, when transferring them to the bending cell, while the glass sheets are being heated, the different sheets may shift out of position with respect to each other. To avoid this, it is preferable to provide vertical stops connected to the lateral tabs 6, said stops holding the sheets in the correct position by the contact between the stops and the narrow edge of the sheets. This guides their sagging.

The skeleton 5′ has dimensions such that when the glass is placed on it, it is far enough from the edge of the glass sheet or sheets for the glass not to form a cavity that is too deep immediately adjacent to the periphery of the sheet (the “bathtub” effect) while it is being transported in the oven, but close enough to it for the desired sag effect and a main deflection to develop. To determine these characteristics of the sag skeleton 5′ as a function of the other parameters of the installation is within the scope of those skilled in the art.

As can be seen in FIGS. 3 and 4, the skeleton 5′ on which the sheet 3 is laid is carried by lateral tabs 6, which in turn are carried by a carriage 7 equipped with wheels 8 traveling on side rails 9 in the oven 10.

In FIG. 3, reference number 11 indicates the walls of the oven, and 12 the position of the bending cell, in the lower part of which is a vertically movable vertical column 13 placed in the center of the frame 4 underneath the male former 2 (these parts 2 and 4 are not shown in FIG. 3), the function of the column 3 being described later. The carriage 7 is equipped with wheels 8 and tabs 6 supporting the skeleton 5′. The wheels of the carriage are on the outside of the oven because the wheel axles pass through horizontal openings in the walls 11. To limit the heat losses through these openings, a refractory fabric (not shown) suspended from above can cover them, and moves away when pushed by the wheel axles, returning automatically to position once they have passed.

When a skeleton 5′ carrying a glazing 3 (one or more superposed sheets) that has developed the required sag arrives in the bending cell 12 (FIG. 5A), the carriage 7 carrying it is stopped over the frame 4 and over the column 13, which are in the down position.

A signal is then given for the column 13 to rise so that it lifts up the skeleton 5′ and its glazing 3 by a base plate 5′a forming part of said skeleton 5′ and the carriage 7 advances to be returned to the entrance of the oven 10 (FIG. 5B). As the skeleton 5′ is being raised by the column 13, it is recentered in the X and Y directions by a two-axis indexing system to place it in the exact position relative to the ring 4.

The frame 4 is then caused to rise to support the periphery of the sheet 3, and the skeleton 5′ discharged from the glass is withdrawn by the column 13 and discharged by a conveying system.

At this point the pressing and partial-vacuum steps are applied (FIGS. 5D and 5E, respectively). These are similar to the pressing and partial-vacuum steps of FIGS. 2C and 2D, respectively. FIG. 6 shows a preferred variant in which a positive gas pressure is produced through the male former 2 toward the central part of the glass. The arrows in FIG. 6 indicate the direction of air movement. Here, the male former 2 is provided with an air-permeable fibrous material 15. The male former is provided with a skirt 16 through which a partial vacuum can be applied in order to keep the glass in contact with the male former 2 even when the female former 4 is lowered.

Next, as before, the frame 4 is lowered and the sheet 3 is kept against the male former 2 by partial vacuum, particularly by the partial vacuum produced through a skirt 16 in the case of a stack of sheets, while a discharging or cooling support 15 (generally a frame) takes the bent sheet 3 away (FIGS. 5F and 5G).

The method described above can also be carried out with a fixed column that does not move vertically, while instead the tabs 6 move downward to deposit the sag support 5′ on the column.

In the case of the prior art in which bent sheets are produced simply by allowing them to sag on the skeleton, the sheets are generally heated to as much as 640-660° C. The process furthermore includes attempting to heat the glass sheet to a greater extent in its central region in order not to give the sheet the shape of a “bathtub”. What is more, in such a process it is very difficult if not impossible to produce a precise shape because of the lack of contact with a solid former.

Standing in contrast to that, in the method as described with reference to FIGS. 3 to 5, it is possible to work advantageously at a temperature of less than 640° C., for example at 590° C.-640° C. and even 590-630° C. The reason for this is that in the oven, and until pressing has begun (mechanical forming) there is no need to introduce the main concavity to obtain the deflection f. Nor is higher local heating of the glass sheet necessary. It is therefore heated evenly.

The fact that the glass is worked at a lower bending temperature, without causing it to break, is advantageous both because it costs less and because there is less risk of modifying the optical, mechanical or other qualities of the glass. Also, when working with a stack of glass sheets separated by a separating powder (calcium carbonate, kieselguhr), there is little or no risk of said powder giving rise to pits or optical defects, especially as it is unnecessary, with the method of the present invention, to lay powder over the entire surface of the glass and as it only has to be placed around the perimeter. It may be observed that certain glass sheets, particularly those intended to form one of the sheets of a windshield, have a coat of black enamel around the periphery of one face. This sheet will be placed in the stack with its black enamel coat turned toward the inside, the separating powder then being placed on the black enamel. In this way, any optical defects that could occur due to the use of the powder will be completely hidden from view when the windshield is fitted to the vehicle.

The use of an even temperature, which does not therefore introduce stresses into the glass, is very useful particularly in the case in which one sheet of a stack comprises, coated on one of its faces, a silver-rich sun-screening film. Such films are known to be liable to crack if heated unevenly.

Types of stacks that can thus be mentioned for forming windshields include conventional stacks having a lower sheet with a peripheral film of enamel on the inside and an upper sheet completely covered with a sun-screen film also on the inside. The bending of such stacks with the application of the separating powder around the periphery only is, with the means of the invention, carried out in the best possible manner. The assembly of a laminated windshield with an interposed plastic (PVB) sheet will be carried out in the conventional way with the two sheets resulting from the same bending operation, after natural cooling at a rate of for example 10° C./second.

Moreover, instead of performing the bending entirely on a skeleton (cooling included), the bent sheets are cooled, with the present invention, more satisfactorily. In the first case the skeleton is in direct contact with the glass from the very beginning of the process. Being metallic, the skeleton cools down faster than the glass, so that extension stresses develop within the glass, making it more fragile and giving rise to a reject rate that is not insignificant.

In the case of the present invention, the cooling frame (which could be replaced by a cooling skeleton) is introduced only after the bending. It is preferably equipped with a knit fabric or felt to insulate the metal frame or skeleton from the glazing and allow air to pass through because of their incomplete contact with the glass.

With the method according to the invention, and for the same production rate, the number of tools necessary is smaller, which helps to ensure closer identity between the manufactured parts. Thus, compared with bending on the skeleton (cooling included), three cooling frames are necessary with the invention instead of 30 to 40 skeletons.

1-12. (canceled)

13. A method of simultaneously bending two or more superposed glass sheets comprising:
allowing the glass sheets to sag under gravity; then
placing a central region of the glass sheets in contact with a male former by advancing a female former supporting the glass sheets toward the male former, the male former being located above the female former with vertical movement of one with respect to the other being possible in a bending cell; then
pressing the glass in its peripheral region between the male former and the female former; then
applying a partial vacuum to the glass through the male former, the pressing being continued, application of the partial vacuum not being commenced until the first glass sheet has made contact with the male former; then
discontinuing the pressing by separating the male former from the female former, the glass remaining in contact with the male former under an effect of a partial vacuum at least partly applied through a skirt surrounding the male former; and then
while the glass is in contact with the male former under the effect of the partial vacuum, bringing a cooling support under the glass, then stopping the partial vacuum to allow the glass sheets to rest on the cooling support, and then taking the glass away for cooling the glass outside the bending cell.

14. The method as claimed in claim 13, wherein the gravity-induced sag is mainly cylindrical and leads to a deflection approximately equal to a final deflection.

15. The method as claimed in claim 13, wherein during the applying the partial vacuum, positive gas pressure is also applied through the male former in a central region of the glass, the male former being covered with a fibrous material.

16. The method as claimed in claim 13, wherein the sag is at least partly brought about in a tunnel oven through which the glass is conveyed toward the bending cell, the glass being placed on a sag support.

17. The method as claimed in claim 13, wherein the sag is at least partly brought about on a sag support occupying an area inscribed entirely, seen from above, within the female former, and the female former moves the glass by rising toward the male former and passing around the sag support.

18. The method as claimed in claim 13, wherein the sag support is a skeleton set back by at least 2 cm from a narrow edge of the glass.

19. The method as claimed in claim 13, wherein the bending is carried out at a temperature of less than 640° C.

20. A bending system for carrying out the method as defined in claim 13, comprising:
an oven including a system for transporting a skeleton-supported glass that moves the skeleton to a bending cell, the cell comprising a frame or annular female former, the skeleton occupying an area inscribed entirely, seen from above, within the annular female former, and a convex male former located above the annular female former;
means for discharging the skeletons from the bending cell; and
means for moving vertically the annular female former, and the male former being provided with means for applying a partial vacuum through its convex surface.

21. The system as claimed in claim 20, wherein a skirt surrounds the male convex former such that a partial vacuum can be applied around the outside of a glazing near a narrow edge of the glass sheet.

22. An application of the method of claim 13 to production of a laminated glazing having locally a coefficient of non-developability greater than 2.
